(19) United States
(12) Patent Application Publication
(10) Pub. No.: US 2025/0098686 A1
(43) Pub. Date: Mar. 27, 2025

(54) Preparation assemblage for coating seed

(71) Applicant: INSTANT SEED GMBH, Mahlow (DE)

(72) Inventors: Thomas KRECISZ, Berlin (DE); Margarethe KRECISZ, Berlin (DE)

(73) Assignee: INSTANT SEED GMBH, Mahlow (DE)

(21) Appl. No.: 18/730,275

(22) PCT Filed: Jan. 17, 2023
(86) PCT No.: PCT/DE2023/000004

§ 371 Date: Jul. 18, 2024

(30) Foreign Application Priority Data
Jan. 21, 2022 (DE) 10 2022 000 218.3

(51) Int. Cl. A01N 63/20; A01C 1/06; A01N 25/04; A01N 25/10; A01N 25/32; A01P 1/00

(52) U.S. Cl. CPC A01N 63/20; A01C 1/06; A01N 25/04; A01N 25/10; A01N 25/32; A01P 1/00

(57) ABSTRACT

The invention concerns a preparation assemblage for coating a seed, containing at least: a biologically degradable wax or a mixture of different such waxes, as well as a biologically effective additive or a plurality of such additives comprising at least one species of a microorganism which promotes root formation and is extrinsic to the seed, a use of such a seed, a seed coated with the preparation assemblage, as well as a method for the production of such a seed.

### FIELD OF THE INVENTION

The invention relates to a preparation assemblage for coating a seed, containing: A) a biologically degradable wax or a mixture of different such waxes, B) optionally, a carrier or a plurality of different carriers, C) optionally, an additive which is different from B) or a plurality of different such additives, D) a biologically effective additive which is different from B) and C) or a plurality of such additives, and E) optionally, water, to the use of such a preparation assemblage, to a seed coated therewith as well as to a method for coating seed.

### PRIOR ART

Seed coatings are used in order to improve the flowability and plantability of the seed, to enable seed to be handled easily in seed preparation units, seed containers and sowing machines, and also in order to raise the yields from a specified quantity of seed.

Preparation assemblages of the aforementioned type and methods for using them are known from the literature—see, for example, US-2016/0345575, U.S. Pat. No. 2,019,758 and DE 19524724 A1. Wax coatings for seed on the one hand and for foodstuffs on the other hand are also known from the literature—see WO2005/077169 A1, DE 60208679 T2 and WO2008/076902 A1.

It is known from other contexts that rhizobia and other microorganisms can promote the germination capability and the growth of plants.

The problem with coating methods which are currently known is that suspensions or dispersions of wax particles in water are used, in fact without a raised temperature when making up such suspensions or dispersions. In addition, these suspensions or dispersions do not take up solids very well.

### TECHNICAL PROBLEM OF THE INVENTION

Thus, the technical problem underlying the invention is the provision of a preparation assemblage and a method for its use, with which seed can be provided with a wax-containing coating which contains viable microorganisms in a quantity which enhances the germination capability and/or growth capability of the seed, while retaining all of the advantages of a conventional seed coating.

### BASIS OF THE INVENTION AND PREFERRED EMBODIMENTS

In order to solve this technical problem, the invention discloses a preparation assemblage for coating a seed, containing:
A) a biologically degradable wax or a mixture of different such waxes,
B) optionally, a carrier or a plurality of different carriers,
C) optionally, an additive which is different from B) or a plurality of different such additives,
D) a biologically effective additive which is different from B) and C) or a plurality of such additives, comprising at least one species of a microorganism which promotes root formation and is extrinsic to the seed, and
E) optionally, water,
wherein the preparation is free from microplastic, and
wherein the components A) to E) may respectively be provided individually or at least partially mixed together.

In particular, the components D) and E) may be provided mixed together. Similarly, the components B), D) and E) may be provided mixed together. It is also possible for components A), B), D) and E) to be provided mixed together. Finally, all of the components A) to E) may be provided mixed together.

With a preparation assemblage in accordance with the invention, all coatings which meet the requirements can be applied to the seed, wherein the microorganisms which are applied with it are viable and therefore the germination and growth of the plants produced from the seed are substantially enhanced, whereupon in addition, the agricultural or silvicultural yield is improved over the prior art. The absence of microplastic (polymer particles with a maximum extent in one direction in space of less than 5 mm), preferably even the absence of any synthetic polymers, additionally constitutes a very considerable contribution to environmental protection.

The invention will now be described in further detail.

In principle, the seed may be any seed and is typically a seed of one or more cultivated plants selected from the group consisting of wheat, rye, barley, triticale, oats or rice; beets, for example sugar beet or fodder beet; fruit such as pome fruit, stone fruit or soft fruit, for example apples, pears, plums, peaches, almonds, cherries, strawberries, raspberries, blackberries or gooseberries; pulses such as, for example, linseed, peas, alfalfa or soya beans; oil plants such as, for example, rape, mustard, olives, sunflower, coconut, cocoa beans, castor oil plant, oil palms, or groundnuts; cucurbits such as pumpkins, cucumbers or melons; fibrous plants such as cotton, flax, hemp or jute; citrus fruit such as oranges, lemons, grapefruit or mandarins; vegetables such as spinach, lettuce, asparagus, cabbage, carrots, onions, tomatoes, potatoes, cucurbits or paprika; aromatic plants such as avocados, cinnamon or camphor; energy crops and raw material crops such as maize, soya beans, rape, sugar beet or oil palms; tobacco; nuts; coffee; tea; bananas; vines (dessert grapes and vines for juicing); hops; natural rubber plants or cultivated and forest plants such as flowers, shrubs, deciduous trees or evergreen plants such as, for example, conifers, acacias, oaks, beeches, yews, firs, pines, birches, sycamores, alders, hornbeams, whitethorns, ashes, holly trees, poplars, stone fruit trees, willows, whitebeams, lindens and elms.

The component A) may be any wax which is suitable in the field of coating seeds. It may be a wax or a mixture of waxes which is or are selected from the group consisting of natural plant or animal waxes, mineral waxes and synthetic or partially synthetic waxes, preferably as an ester of at least one unbranched alkanoic acid containing 22 or more carbon atoms, fatty acid, or a short-chain saturated hydroxylated fatty acid, in particular docosanoic acid, tricosanoic acid, tetracosanoic acid, pentacosanoic acid, hexacosanoic acid, heptacosanoic acid, octacosanoic acid, nonacosanoic acid, triacontanoic acid, hentriacontanoic acid, dotriacontanoic acid, tritriacontanoic acid, tetratriacontanoic acid, sabinic acid, juniperic acid, thapsic acid, palmitic acid, stearic acid, or mixtures of 2 or more such alkanoic acids, and at least one aliphatic monovalent alcohol containing 6 or more carbon atoms, in particular 1-hexanol, 1-heptanol, 1-octanol, 1-decanol, 1-dodecanol, 1-tetradecanol, 1-hexadecanol, 1-heptadecanol, 1-octadecanol, 1-eicosanol, 1-docosanol, 1-tetracosanol, 1-hexacosanol, 1-octacosanol, 1-triacontanol, cis-9-hexadecen-1-ol, cis-9-octadecen-1-ol, trans-9-octadecen-1-ol, cis-11-octadecen-1-ol, cis, cis-9, 12-octadecadien-1-ol, or 6,9, 12-octadecatrien-1-ol (γ-linolenyl alcohol) or mixtures of 2 or more such alcohols.

The component A) may be present as a solid, wherein the particle size of the component A) is preferably below 300 um, in particular below 100 μm, measured with a test sieve with an appropriate mesh size. Component A) typically but not necessarily has a melting point of at least 30° C., preferably at least 40° C., and a maximum of 140° C., for example a maximum of 80° C., preferably a maximum of 60° C., in particular a maximum of 50° C. The component A) may be dispersed in the component E).

The component B) is preferably an additive which is capable of swelling or does not swell in water, for example selected from mineral earths such as silicates, silicas, gels, hydrogels, talc, kaolins, limestone, lime, chalk, loess, clays, dolomite rock, diatomaceous earth, calcium sulphate, magnesium sulphate, magnesium oxide, ground synthetic materials, and/or a fertiliser such as, for example, ammonium sulphate, ammonium phosphate, ammonium nitrate, ureas, and/or products of plant origin such as, for example, cereal flour, tree bark flour, wood flour and nut shell flour, cellulose powder, peat (preferred) and mixtures of different such additives, wherein the particle size of these additives is preferably below 300 μm, in particular below 100 μm, measured with a test sieve with an appropriate mesh size.

The expression “capable of swelling” indicates that the component B) in question retains water. In this case, it is possible for the component D) to be introduced into the component B) as an aqueous solution or suspension and is stored in it, and in fact without component D) drying out, which is advantageous, depending on the type of component D) (for example a liquid or aqueous preparation with microorganisms).

The component C) may be selected from non-aqueous solvents such as, for example, mineral oil fractions with a medium to high boiling point, such as kerosene or diesel oil, coal tar oils and oils of plant or animal origins, aliphatic, cyclic and aromatic hydrocarbons, for example toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gamma-butyrolactone, fatty acid dimethylamides, fatty acids and fatty acid esters, as well as strongly polar solvents, for example amines such as N-methylpyrrolidone.

Alternatively or in addition, the component C) may be selected from one or more agents from the group consisting of surfactants, dispersing agents, emulsifying agents, solubility promoters and bonding agents and protective colloids, such as, for example, alkaline, alkaline-earth and metallic and ammonium salts of aromatic sulphonic acids such as lignosulphonic acid (Borresperse® series, Borregard, Norway), phenolsulphonic acid, naphthalene sulphonic acid (Morwet® series, Akzo Nobel, U.S.A.), dibutylnaphthalene sulphonic acid (Nekal® series, BASF, Germany), and fatty acids, alkylsulphonates, alkylarylsulphonates, alkylsulphates, laurylethersulphates, fatty alcohol sulphates and sulphated hexa-, hepta- and octadecanolate, sulphated fatty alcohol, glycol ethers, further condensates of naphthalene or of naphthalene sulphonic acid with phenol and formaldehyde, polyoxyethylene-octylphenylether, ethoxylated isooctylphenol, octylphenol, nonylphenol, alkylphenyl polyglycolether, tributylphenyl polyglycolether, tristearylphenyl polyglycolether, alkylarylpolyether alcohols, alcohol and fatty alcohol-ethylene oxide condensates, ethoxylated castor oil, polyoxyethylene alkylether, ethoxylated polyoxypropylene, laurylalcohol polyglycol etheracetal, sorbitol esters, lignin sulphite waste liquor and proteins, denatured proteins, polysaccharides (for example methylcellulose), hydrophobically modified starches, maleic acid anhydride diisobutylene copolymers, polyvinylalcohols (Mowiol® series, Clariant, Switzerland), polycarboxylates (Sokolan® series, BASF, Germany), polyalkoxylates, polyvinylamines (Lupasol® series, BASF, Germany), polyvinylpyrrolidone and copolymers thereof.

As an alternative or in addition, the component C) may contain organic and inorganic thickening agents such as, for example, polysaccharides as well as organic and inorganic clays, such as xanthan rubber (Kelzan®, C P Kelco, U.S.A.), Rhodopol® 23 (Rhodia, France), Veegum® (R. T. Vanderbilt, U.S.A.) or Attaclay® (Engelhard Corp., NJ, USA).

Cryoprotective agents may also be used in the component C) such as, for example, ethylene glycol, propylene glycol, urea and glycerine, and/or anti-foaming agents such as, for example, silicone emulsions (such as, for example, Silikon RSRE, Wacker, Germany or Rhodorsil®, Rhodia, France, or dimethylpolysiloxanes), long-chain alcohols, fatty acids, salts of fatty acids, fluoro-organic compounds.

Finally, the component C) may contain colorants such as, for example, water-insoluble pigments or water-soluble dyes such as Rhodamin B, Solvent Red 1, Pigment Blue 15:4, Pigment Blue 15:3, Pigment Blue 15:2, Pigment Blue 15:1, Pigment Blue 80, Pigment Yellow 1, Pigment Yellow 13, Pigment Red 112, Pigment Red 48:2, Pigment Red 48:1, Pigment Red 57:1, Pigment Red 53:1, Pigment Orange 43, Pigment Orange 34, Pigment Orange 5, Pigment Green 36, Pigment Green 7, Pigment White 6, Pigment Brown 25, Basic Violet 10, Basic Violet 49, Acid Red 51, Acid Red 52, Acid Red 14, Acid Blue 9, Acid Yellow 23, Basic Red 10, Basic Red 108, Acid Red 18-Food Red 7, Food Red 1, Pearlescent Pigment 1025, Pearlescent Mica/TiO2 Pigment, mica flakes coated with titanium dioxide and/or iron oxide.

The essential ingredient of component D) is preferably selected from a strain of rhizobia or a plurality of different strains of rhizobia such as, for example, Bradyrhizobium japonicum, Bradyrhizobium japonicum, Sinorhizobium meliloti, Bradyrhizobium sp. Lupini, Rhizobium leguminosarum biovar viceae, naturally occurring or genetically modified, and bacteria which have been genetically engineered with rhizobia genes. In general, however, in essence, any microorganisms which promote the germination capability of seeds and/or the growth of plants may be used.

The component D) may furthermore contain commercially available bactericides such as, for example, bactericides based on dichlorophen and benzyl alcohol hemi formal (Proxel®) from ICI or Acticide® RS from Thor Chemie and Kathon® MK from Rohm & Haas) and isothiazolinone derivatives such as alkylisothiazolinones and benzisothiazolinones (Acticide®), and/or water-based 1,2-benzisothiazolin-3-one (CAS No. 2634-33).

The component D) may furthermore contain commercially available pesticides such as, for example, strobilurins, carboxamides, azoles, heterocyclic compounds, carbamates, and/or growth regulators, and/or commercially available fungicides, herbicides, insecticides, acaricides and/or nematicides.

Finally, the component D) may contain agents for protecting against damage of the seed by the aforementioned materials such as, for example, 8-quinolinyl-oxyacetic acids (such as Cloquintocet-mexyl), 1-phenyl-5-haloalkyl-1,2,4-triazol-3-carbonic acids (such as Fenchlorazol and Fenchlorazol-ethyl), 1-phenyl-5-alkyl-2-pyrazolin-3,5-dicarbonic acid (such as Mefenpyr and Mefenpyr-diethyl), 4,5-dihydro-5,5-diaryl-1,2-oxazol-3-carbonic acids (such as Isoxadifen and Isoxadifen-ethyl), dichloracetamides (such as Dichlormid, Furilazol, Dicyclonon and Benoxacor), alpha-(alkoxyimino)-benzeneacetonitrile (such as Cyometrinil and Oxabetrinil), acetophenone, oximes (such as Fluxofenim), 4,6-dihalogeno-2-phenylpyrimidines (such as Fenclorim), N-((4-alkylcarbamoyl)-phenylsulphonyl)-2-benzamides (such as Cyprosulfamid), 1,8-naphthalic acid anhydride, 2-halogen-4-haloalkyl-1, 3-thiazol-5-carbonic acids and 2-halogen-4-haloalkyl-1, 3-thiazol-5-carboxylates (such as Flurazol), N-alkyl-O-phenylcarbamates (such as Mephenat), N-alkyl-N′-arylureas (such as Daimuron and Cumyluron), S-alkyl-N-alkyl-thiocarbamates (such as Dimepiperat) and phosphorothioates (such as Dietholat), as well as their agriculturally useful salts or derivatives such as, for example, amides, esters and thioesters in the case in which carbonic acid functions are present.

The components A) and D) may be mixed together. When the microorganisms of the component D) are moist, then the component E) is also mixed into the component A). If, for example, Histick® is used (microorganisms, moist, in peat, independently of the aforementioned product), it is also possible here for the components A), B), D) and E) to be mixed together. Clearly, the component C) may also be mixed in. The preparation assemblage is then a single-component set.

In a preparation assemblage in accordance with the invention, the components are mixed together or are separate from each other and preferably are contained in it in the following proportions:
a) 1-90% by weight of the component A), in particular 5-70% by weight, preferably 10-50% by weight,
b) 0-70% by weight of the component B), in particular 1-70% by weight, preferably 1-50% by weight, most preferably 5-50% by weight,
c) 0-30% by weight of the component C), in particular 0.01-10% by weight, preferably 0.1-20% by weight,
d) 0.01-30% by weight of the component D), in particular 0.1-10% by weight, preferably 0.1-20% by weight,
e) 0-99% by weight of the component E), in particular 0.1-99% by weight, preferably 5-50% by weight,
wherein the sum of quantities a) to e) always adds up to 100% by weight.

Furthermore, the invention concerns the use of a preparation assemblage in accordance with the invention for coating a seed as well as a seed coated using a preparation assemblage in accordance with the invention.

Finally, the invention also encompasses a method for the production of a seed in accordance with the invention, with the following steps of the method:
V1) the seed is placed in a coating unit, circulated and heated to a temperature of at least 30° C., in particular at least 40° C.,
V2) the components A) and D), optionally also the components B), C) and/or E), are simultaneously or consecutively placed in the coating unit, wherein the component A) is at a temperature of at most 60° C., in particular at most 50° C., in particular at most 40° C., V3) the seed and the components of the preparation placed in step V2) are circulated together to form the coated seed,
V4) the coated seed is cooled to room temperature and then removed from the coating unit.

The steps V1) to V4) may be carried out here in a single coating vessel, or the steps V1) to V4) may be carried out in a plurality of, namely 2, 3 or 4, separate coating vessels, wherein the plurality of coating vessels are connected together with transportation devices in order to transport the product of one step of the method into the coating vessel of the next step of the method.

The essential aspect of the method lies in the at least mild increase in the temperature, compared with the prior art in which wax dispersions are applied to the seed without heating.

The invention will now be described in more detail with the aid of a single exemplary embodiment of the depicted method. In the figures:

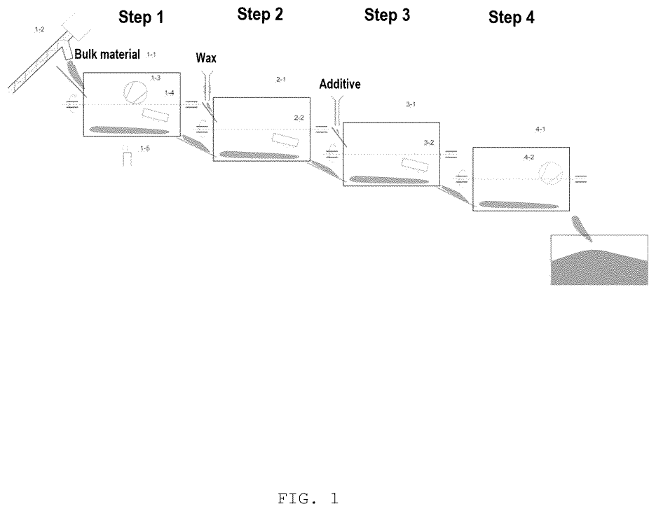

FIG. 1: shows a process diagram for the method.

Waxes (animal, plant, mineral or synthetic) which form smooth, thin and water-repellent films because of their properties, have many applications in many fields, inter alia as polishes and for waterproofing. Waxes melt from approximately 40° C. to form a liquid. Hard fats have similar properties to wax and can be used in similar manners to waxes. Only the use of wax will be described below, however.

The aim of a water-repellent coating is:
to protect a grain from water penetration, to inhibit the uptake of water or to protect the grain from drying out,
to attach ingredients to the surface of the grain, wherein in some cases, the ingredients should not come into contact with water during the production of the layer or should not be released from the surface under the influence of moisture.

A layer of wax is applied to a grain by immersion or spraying with aqueous liquid which contains the dispersed, wax-like ingredients.

In practice, it is generally known to coat with a hydrogel or to attach the hydrogel to grains. This is employed in the production of what are known as microgreens.

Hydrogel takes up water relatively rapidly and its volume increases. This means that it is almost impossible to use hydrogel in an aqueous environment. In order to enable it to be used, the hydrogel particles are enrobed in a film of wax. However, the wax film does not cover 100% of the surface. Pores are left and cracks are formed. The thinner the layer, the small is the covered surface/pore ratio. The ratio increases with thicker layers.

It is desirable to produce a predefined layer thickness. While it can be influenced by the quantity of wax/quantity of hydrogel ratio, this is difficult to achieve because of a non-uniform distribution of the wax on the surface of the grain (also, the size of the surface varies as a function of the grain size and grain shape). And the covered surface/pore ratio is a decisive factor in the water absorption properties of a grain.

The water absorption properties can be varied by adding various additives to the coating. These may be materials which channel water, such as clay, or indeed materials such as sand, which transports water to the interfaces.

The materials which are in the coating can be visualised as behaving in a similar manner to sand in a plastic bag when the bag has small holes. If a bag like this is immersed in water, a lot of water enters it relatively quickly. However, the sand will require much more time for the water to evaporate through the holes and for it to become dry.

The materials are encapsulated in wax, but there are cracks and gaps which are produced during cooling of the wax and its solidification, and there are holes which are produced because the integrity of the coat is incomplete.

In the context of developing the present invention, experiments were carried out in order to investigate the water-storing action of various coats on some types of tree seeds (acacia, oak). Two types of plant wax were used: rape wax and soya wax. Both waxes are biologically degradable and are eminently suitable for coating seeds.

Various additives were added to the wax layer. Hydrogel above all, but also clay, wood flour and cellulose were tested as water reservoirs. The coatings which were produced proved to be relatively solid and smooth (no dust, abrasion-resistant). The prerequisite was that the additives had been ground relatively finely. The grain size depends on the properties of the additives and the shape of the seed, but in principle should not exceed 0.1 mm.

Irrespective of which wax or additives were used, the coating has no negative influence on the germination capability or the germination period of the seeds. This finding led to the conclusion that active ingredients could also be added to the coating.

Additives which increase their volume when water is added appear to be of great significance. Because of the increase in volume, they burst the wax layer and in this manner they enable better contact of water with the active ingredients in the wax layer. The additives primarily include hydrogel, many bentonites and clay, as well as other minerals. The wax layer does not appear to be of any significance as regards germination, because after the initial take-up of water by the seed, its volume increases and the wax layer will burst.

The invention may be deployed in many fields. It is particularly suitable for coating seed stock, during which many active ingredients can be applied to the seed stock in a simple manner.

In more detail, a method in accordance with the invention may be implemented as follows, in conjunction with FIG. 1. In principle, it may be carried out discontinuously (in batches) or continuously. By way of example, the method is divided into four discrete steps in various coating vessels, but it is also possible to carry out the steps in a single coating vessel. Rotary drums may, for example, be used as the coating vessels.

Step 1: the seed stock is transported by means of a conveyor, for example a spiral conveyor 1-2, into a rotating rotary drum 1-1. In the rotary drum 1-1, the seed stock is heated relatively rapidly to a temperature which is higher than the melting temperature of the component A). Heating may be carried out by means of a hot air blower 1-3, an infrared emitter 1-4, a flame 1-5, or in another manner. The duration of the heating is selected subject to the proviso that only the surface region of the grains of the seed stock is heated to said temperature, on the one hand for the purposes of saving energy, on the other hand in order to avoid damage to the grains, which could inhibit subsequent germination. The heating rate in this regard is controlled and set by the power and temperature of the heat source on the one hand and by the flow rate of the bulk material or mixing of the bulk material. The former is achieved by selecting the size and the angle of inclination of the rotary drum. Mixing of the bulk material is accomplished by selecting the shape and the internal surface area of the rotary drum. The temperature of the seed stock (or of the surface regions of the grains) may also be selected so as to be lower than this, but then a higher temperature has to be selected in the steps 2 and/or 3 described below. Next, the seed is transferred into the rotary drum 2-1.

Step 2: here, the component A) is added to the bulk material in a rotating rotary drum 2-1. The component A) is in powdered form and can optionally be heated to a temperature below the melting temperature prior to addition. The temperature of the bulk material should be higher than the melting temperature of component A), and in fact higher by an amount such that the quantity of heated stored in the bulk material is sufficient to heat the added component A) to its melting temperature and to melt it. If the bulk material in step 1 has been heated to a temperature which is in fact too low, then the mixture of bulk material and component A) can be additionally heated, for example with the infrared emitter 2-2. Hot air or heating the rotary drum would be less suitable, because a stream of air would blow particles of component A) away and they could melt on the hot rotary drum. Pre-heating the component A) can preheat the bulk material to a lower temperature.

Step 3: the component D) and optionally the components B), C) and E) are added to the bulk material with component A) transported out of the rotating rotary drum 2-1 into the rotating rotary drum 3-1. These components have been individually described in the general section of the description. These components stick to the component A) adhering to the seed stock and are at least partially covered with component A) during the implementation of this step. It is possible also to add additional component A) in this step 3. In this regard, it may be a component A) which has a lower melting point than the component A) added in step 2. This is particularly appropriate when the components D) and possibly B) and C) are to be covered with a thicker layer of component A). The process is controlled in this step in this regard in a manner such that the temperature of the bulk material is relatively low, so that the microorganisms of component D) are not damaged at all, or damage is only slight. In addition, appropriately, the duration of the raised temperature is kept as short as possible. Notwithstanding this, heat may be added by means of an infrared emitter 3-2 if this is of advantage to the continuation of the coating process. In the case of temperature-sensitive components B) to D) and when these components have to come into contact with the surface of grains of the seed stock, these may also be added in step 2. In this case, steps 1 to 3 may even be combined into a single step in a single rotary drum 1-1.

Step 4: the bulk material is cooled with cooling air 4-2 in the rotating rotary drum 4-1. Depending on the dwell time in this rotary drum, the layer of the component A) may also solidify, but as long as this layer is still warm, the component A) on the surface will be smeared and polished, whereupon the other added components will additionally be covered with component A).

1. A preparation assemblage for coating a seed, comprising:
A) a biologically degradable wax or a mixture of different such waxes,
B) optionally, a carrier or a plurality of different carriers,
C) optionally, an additive which is different from B) or a plurality of different such additives,
D) a biologically effective additive which is different from B) and C) or a plurality of such additives, comprising at least one species of a microorganism which promotes root formation and is extrinsic to the seed, and
E) optionally, water,
wherein the preparation is free from microplastic, and
wherein the components A) to E) may respectively be provided individually or at least partially mixed together.

2. The preparation assemblage as claimed in claim 1, wherein the seed is seed of one or more cultivated plants which is selected from the group consisting of wheat, rye, barley, triticale, oats or rice; beets selected from the group consisting of sugar beet or fodder beet; fruit selected from the group consisting of pome fruit, stone fruit or soft fruit, selected from the group consisting of apples, pears, plums, peaches, almonds, cherries, strawberries, raspberries, blackberries or gooseberries; pulses selected from the group consisting of linseed, peas, alfalfa or soya beans; oil plants selected from the group consisting of rape, mustard, olives, sunflower, coconut, cocoa beans, castor oil plant, oil palms, or groundnuts; cucurbits selected from the group consisting of pumpkins, cucumbers or melons; fibrous plants selected from the group consisting of cotton, flax, hemp or jute; citrus fruit selected from the group consisting of oranges, lemons, grapefruit or mandarins; vegetables selected from the group consisting of spinach, lettuce, asparagus, cabbage, carrots, onions, tomatoes, potatoes, cucurbits or paprika; aromatic plants selected from the group consisting of avocados, cinnamon or camphor; energy crops and raw material crops such as maize, soya beans, rape, sugar beet or oil palms; tobacco; nuts; coffee; tea; bananas; vines; hops; natural rubber plants or cultivated and forest plants such as selected from the group consisting of flowers, shrubs, deciduous trees or evergreen plants selected from the group consisting of conifers, acacias, oaks, beeches, yews, firs, pines, birches, sycamores, alders, hornbeams, whitethorns, ashes, holly trees, poplars, stone fruit trees, willows, whitebeams, lindens and elms.

3. The preparation assemblage as claimed in claim 1, wherein the component A is selected from the group consisting of natural plant or animal waxes, mineral waxes and synthetic or partially synthetic waxes.

4. The preparation assemblage as claimed in claim 1, wherein the component A) is present as a solid.

5. The preparation assemblage as claimed in claim 1, wherein the component A) has a melting point of at least 30° C., and a maximum of 80° C.

6. The preparation assemblage as claimed in claim 1, wherein the component B) is an additive which swells or does not swell in water, and is selected from silicates, silicas, gels, hydrogels, talc, kaolins, limestone, lime, chalk, loess, clays, dolomite rock, diatomaceous earth, calcium sulphate, magnesium sulphate, magnesium oxide, ground synthetic materials, ammonium sulphate, ammonium phosphate, ammonium nitrate, ureas, cereal flour, tree bark flour, wood flour and nut shell flour, cellulose powder, and mixtures of different such additives, wherein the particle size of these additives is below 300 μm, measured with a test sieve with an appropriate mesh size.

7. The preparation assemblage as claimed in claim 1, wherein the component C) is selected from non-aqueous solvents and/or from one or more agents from the group consisting of surfactants, dispersing agents, emulsifying agents, solubility promoters and bonding agents and protective colloids, organic and inorganic thickening agents, cryoprotective agents, anti-foaming agents, and/or colorants.

8. The preparation assemblage as claimed in claim 1, wherein the component D is selected from a strain of rhizobia or a plurality of different strains of rhizobia, bacteria which have been genetically modified with rhizobia genes, bactericides which are not damaging to the microorganisms cited above, pesticides, fungicides, herbicides, insecticides, acaricides, nematicides, and/or agents for protecting against damage to the seed and/or for protecting the microorganisms present from damage by the aforementioned materials.

9. The preparation assemblage as claimed in claim 1, containing
a) 1-90% by weight of the component A),
b) 0-70% by weight of the component B),
c) 0-30% by weight of the component C),
d) 0.01-30% by weight of the component D),
e) 0-99% by weight of the component E),
wherein the sum of quantities a) to e) always adds up to 100% by weight.

10. A method for coating a seed comprising coating the seed with the preparation assemblage as claimed in claim 1.

11. Seed coated using a preparation assemblage as claimed in claim 1.

12. A method for the manufacture of a seed as claimed in claim 11, with the following steps of the method:
V1) the seed is placed in a coating unit, circulated and heated to a temperature of at least 30° C.,
V2) the components A) and D), optionally also the components B), C) and/or E), are simultaneously or consecutively placed in the coating unit, whereupon a constant circulation is carried out, and wherein the component A) is at a temperature of at most 60° C., V3) the seed and the components of the preparation placed in step V2) are circulated together to form the coated seed, and
V4) the coated seed is cooled to room temperature and then removed from the coating unit.

13. The method as claimed in claim 12, wherein the steps V1) to V4) are carried out in a single coating vessel, or wherein the steps V1) to V4) are carried out in a plurality of separate coating vessels, wherein the plurality of coating vessels are connected together with transportation devices in order to transport the product of one step of the method into the coating vessel of the next step of the method.

14. The preparation assemblage as claimed in claim 1 wherein the particle size of the component A) is below 300 μm, measured with a test sieve with an appropriate mesh size.

15. The preparation assemblage as claimed in claim 1 wherein the particle size of the component A) is below 100 μm, measured with a test sieve with an appropriate mesh size.

16. The preparation assemblage as claimed in claim 1 wherein the component A) has a melting point of at least 40° C., and a maximum of 60° C.

17. The preparation assemblage as claimed in claim 1 wherein the particle size of the additives is below 100 μm, measured with a test sieve with an appropriate mesh size.

18. The preparation assemblage as claimed in claim 1 wherein the preparation assemblage comprises 5-70% by weight of the component A), 1-50% by weight of the component B), 0.01-10% by weight of the component C), 0.1-10% by weight of the component D), and 0.1-99% by weight of the component E).

19. The preparation assemblage as claimed in claim 1 wherein the preparation assemblage comprises 10-50% by weight of the component A), 5-50% by weight of the component B), 0.1-20% by weight of the component C), 0.1-20% by weight of the component D), and 5-50% by weight of the component E).

20. The method of claim 12 wherein in the step V1), the seed is placed in a coating unit, circulated and heated to a temperature of at least 40° C., and in the step V2), the component A) is at a temperature of at most 50° C.

21. The method of claim 13 wherein the plurality of separate coating vessels are 2, 3, or 4 separate coating vessels.
